(19) United States
(12) Patent Application Publication
(10) Pub. No.: US 2005/0035931 A1
(43) Pub. Date: Feb. 17, 2005

(54) Plasma display panel driving method and plasma display device

(76) Inventors: Hun-Suk Yoo, Suwon-si (KR); Kyoung-Doo Kang, Suwon-si (KR); Woo-Tae Kim, Suwon-si (KR); Jae-Ik Kwon, Suwon-si (KR); Seok-Gyun Woo, Suwon-si (KR)

Correspondence Address: Robert E. Bushnell;Suite 300, 1522 K Street, N.W., Washington, DC, 20005-1202, US

(21) Appl. No.: 10/916,613

(22) Filed: Aug. 12, 2004

(30) Foreign Application Priority Data
Aug. 12, 2003 (KR) 2003-55837

(51) Int. Cl. G09G 3/28

(52) U.S. Cl. 345/63

(57) ABSTRACT

Disclosed is a PDP driving method and a plasma display device for providing stable discharge characteristics by varying gradients of PDP driving waveforms according to the external temperature of the PDP. A protection film of MgO reduces the secondary emission coefficient as the temperature is reduced. In order to compensate for the reduction, the external temperature is measured by an external temperature sensor, and the gradients in a falling period and/or the rising period during a reset period of a driving voltage waveform are modified according to the measured external temperature. In detail, the gradients in the falling period and/or the rising period of the reset period are varied to be less steep when the measured temperature is reduced to below a predetermined level such as freezing or −10 degrees C.

### CLAIM OF PRIORITY

This application makes reference to, incorporates the same herein, and claims all benefits accruing under 35 U.S.C. §119 from an application for PLASMA DISPLAY PANEL DRIVING METHOD AND PLASMA DISPLAY DEVICE earlier filed in the Korean Intellectual Property Office on 12 Aug. 2003 and there duly assigned Serial No. 2003-55837.

### BACKGROUND OF THE INVENTION

1. Field of the Invention

The present invention relates to a PDP (plasma display panel) driving method and a plasma display device. More specifically, the present invention relates to a PDP driving method and a plasma display device that compensates for low temperatures by modifying voltage gradients in a reset period.

2. Description of the Related Art

The PDP is a flat display that uses plasma generated via a gas discharge process to display characters or images, and tens to millions of pixels are provided thereon in a matrix format, depending on its size. In order to display the images, voltages need to be applied between electrodes in each pixel to address and to function the display.

A problem occurs when the PDP is in a cold environment, causing the voltages applied to the electrodes to very and thus causing the PDP to not function properly. Therefore, what is needed is a design for a PDP and a method that can compensate for cold temperatures so that images can be displayed properly, even if the PDP is in sub-freezing environment.

### SUMMARY OF THE INVENTION

It is therefore an object of the present invention to provide an improved design for a PDP.

It is also an object of the present invention to provide an improved method for driving a PDP.

It is also an object of the present invention to provide a PDP that can function properly in sub-freezing temperatures.

It is also an object of the present invention to provide a PDP that can compensate for extreme cold temperatures.

It is still an object of the present invention to provide a method for compensating for cold temperatures in a PDP.

These and other objects can be achieved with a plasma display device for temporally arranging a plurality of subfields and displaying gray scales, the PDP including a plurality of address electrodes, a plurality of scan electrodes and sustain electrodes arranged in pairs with the address electrodes, an external temperature sensor for measuring the external temperature of the PDP, a logic unit having a memory for storing gradient data of a rising and falling voltage rates during a reset period according to the external temperature measured by the external temperature sensor, and a driving circuit for driving the PDP according to the gradient data of a varied voltage transmitted from the logic unit.

In another aspect of the present invention, a method for driving a PDP that compensates for cold temperatures that includes measuring an external temperature of the PDP, during a reset period, controlling a gradient of a falling voltage applied to a first electrode according to the external temperature of the PDP, and applying a voltage. In this instance, the method further includes, during the reset period, controlling a gradient of a rising voltage applied to the first electrode according to the external temperature of the PDP, and applying a voltage. The falling gradient applied to the first electrode becomes less when the temperature measured is lower.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a partial perspective view of a PDP;

FIG. 2 illustrates a graph of the dependence of the secondary emission coefficient “γ” versus external temperature;

FIG. 3 illustrates a block diagram of a plasma display device according to an exemplary embodiment of the present invention;

FIG. 4A illustrates a voltage waveform in a reset period before the gradients are varied;

FIG. 4B illustrates a voltage waveform with varied falling gradient only in the reset period according to an exemplary embodiment of the present invention; and

FIG. 4C illustrates a voltage waveform with varied rising and falling gradients in the reset period according to another exemplary embodiment of the present invention.

### DETAILED DESCRIPTION OF THE INVENTION

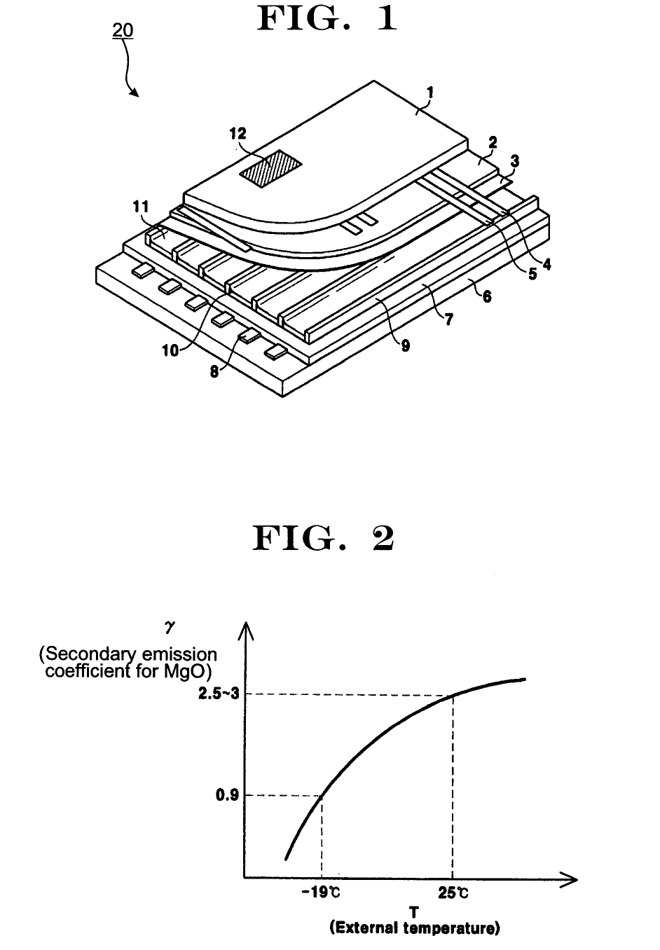

Turning now to the figures, FIG. 1 illustrates a PDP configuration 20. As illustrated in FIG. 1, the PDP 20 includes two glass substrates 1 and 6 facing with each other with a gap therebetween. A pair of a scan electrode 4 and a sustain electrode 5 are formed parallel to each other and forming a pair on substrate 1 and are covered with a dielectric layer 2 and a protection film 3 made of MgO. A plurality of address electrodes 8 covered with an insulation layer 7 are formed on the glass substrate 6. Barrier ribs 9 are formed on the insulation layer 7 between adjacent address electrodes 8, and phosphors 10 are formed on the surface of the insulation layer 7 and both surfaces of the barrier ribs 9. The glass substrates 1 and 6 are provided to face each other with a discharge space 11 therebetween so that the scan electrode 4 may cross the address electrode 8 and the sustain electrode 5 may cross the address electrode 8. The discharge spaces 11 provided on the crossing nodes between the address electrodes 8 and the scan electrode 4 and the sustain electrode 5 in a pair form discharge cells 12.

A method for driving the PDP 20 of FIG. 1 has a reset period, an address period, a sustain period, and an erase period in a temporal operation manner. Within the reset period is a rising period and a falling period and may also include other time periods where the voltage essentially remains the same. During the rising and the falling periods, the voltage generally varies by a fixed amount per unit time, or in other words, the voltage as plotted against time forms an essentially straight line with a fixed slope during the rising and the falling periods of the reset period. This slope or rate of increase and decrease of voltage per unit time is often referred to here as the “gradient” of the voltage waveform. Gradients of a waveform during the reset period substantially influence discharges, and in general, the gradients in the reset period are preferably between 1.5 and 3.5 V/μsec, and the gradients of a falling period in the reset period are preferably between 0.5 and 1.5 Vμsec. The gradients are established to have values suitable for the PDP characteristics.

In the case of the waveform during the reset period with the above-noted gradients, the protection film 3 (generally made of MgO) normally emits secondary electrons at room temperature (25° C.), and hence a normal wall charge is built up, and thus a stable operation during the address period is possible. However, in the case that the external temperature is below −10° C., the secondary emission coefficient “γ” of the protection film 3 is lower than it is at room temperature, causing the characteristic of the secondary emission to be degraded.

Turning now to FIG. 2, FIG. 2 illustrates a graph of secondary emission coefficient “γ” (where γ(T) meaning that the secondary emission coefficient is a function of temperature) for MgO versus external temperature “T”. As illustrated in FIG. 2, the secondary emission coefficient “γ” is lower as the external temperature is decreased. Therefore, the characteristic of the secondary emission coefficient “γ” is lowered at low temperatures, a stable drive of the PDP is not performed, and either selected cells are not normally operated or the cells which are not selected are discharged.

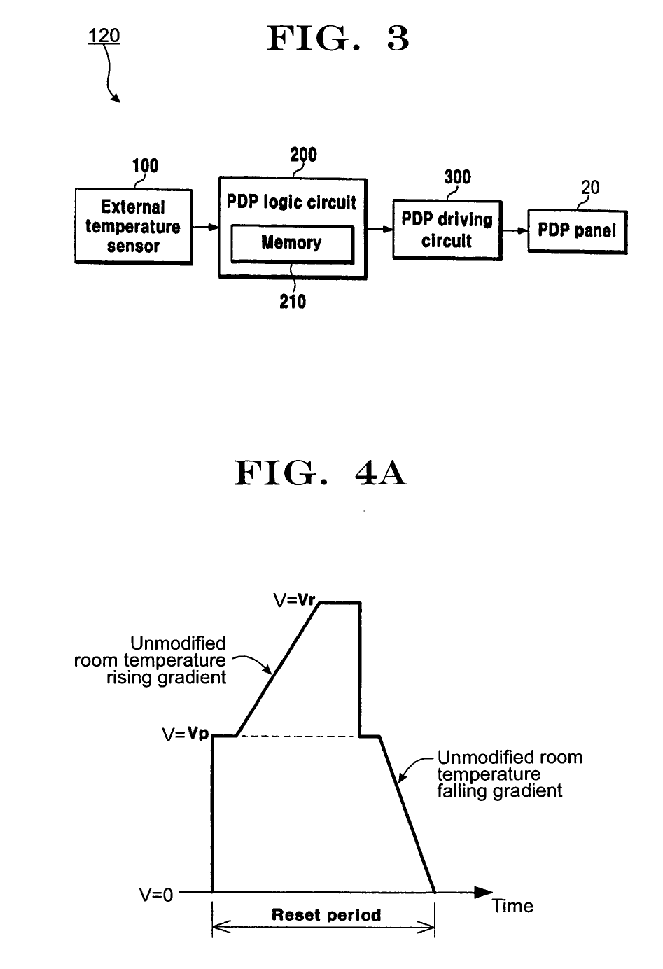

Turning now to FIG. 3, FIG. 3 illustrates a block diagram of a plasma display device 120 according to an exemplary embodiment of the present invention. Referring to FIG. 3, the plasma display device 120 has an external temperature sensor 100, a PDP logic circuit 200, a PDP driving circuit 300, and a PDP panel 20.

The external temperature sensor 100 measures the external temperature of the PDP 20. At cold, sub-freezing temperatures, the secondary emission coefficient “γ” of the MgO protection film 3 formed on the PDP 20 much lower than at room temperature as previously illustrated in FIG. 2. In the plasma display device 120 of the present invention, the external temperature sensor 100 measures the external temperature in order to prevent the erroneous operation caused by cold temperatures.

The external temperature sensor 100 measures the external temperature, and transmits information on the external temperature as signals to the PDP logic circuit 200. In detail, since the secondary emission coefficient “γ” is problematic in the condition of below a predetermined temperature and is not problematic at room temperature or at high temperatures, the external temperature sensor 100 can be arranged to transmit information on the external temperature as signals to the PDP logic circuit 200 only when the temperature is below a constant (e.g., below 0° C.). The external temperature sensor 100 can be located inside or outside the PDP 20 in order to measure the external temperature.

When receiving the information on the external temperature from the external temperature sensor 100, the PDP logic circuit 200 modifies a gradient of the driving waveform, that is, a gradient value of either a falling period and/or a rising period of a waveform in the reset period through modified value(s) according to the external temperature, and transmits the modified gradient value(s) to the PDP driving circuit 300. The change of voltage with time for the falling and/or the rising period of the reset period can be adjusted to overcome the problem of extreme cold.

The PDP logic circuit 200 includes a memory 210 which contains a lookup table that stores and maps voltage gradient values for the falling period and/or the rising period of the voltage waveforms during the reset period against on the sensed external temperature. The general gradient of the rising period in the reset period is given as between 1.5 and 3.5 V/μsec, and a stable reset operation is allowed by increasing the rising period voltage gradient to values between 3.5 and 5V/μsec when the external temperature is below 0° C., and increasing the falling gradient in the reset period from the values of between 0.5 and 1.5V/μsec to gradient values of between 1.5 and 5V/μsec. However, since the exact voltage gradient values vary depending on the model and design of a PDP, the above values are examples of data and in no way is the present invention limited to these gradient ranges. Further, since the preferred gradient ranges can vary from model to model, the look up table linking falling and/or rising gradients with external temperature are stored in the memory 210. The data stored in this memory 210 can vary from model to model. This allows different gradient values for different temperatures to be stored for different models easily.

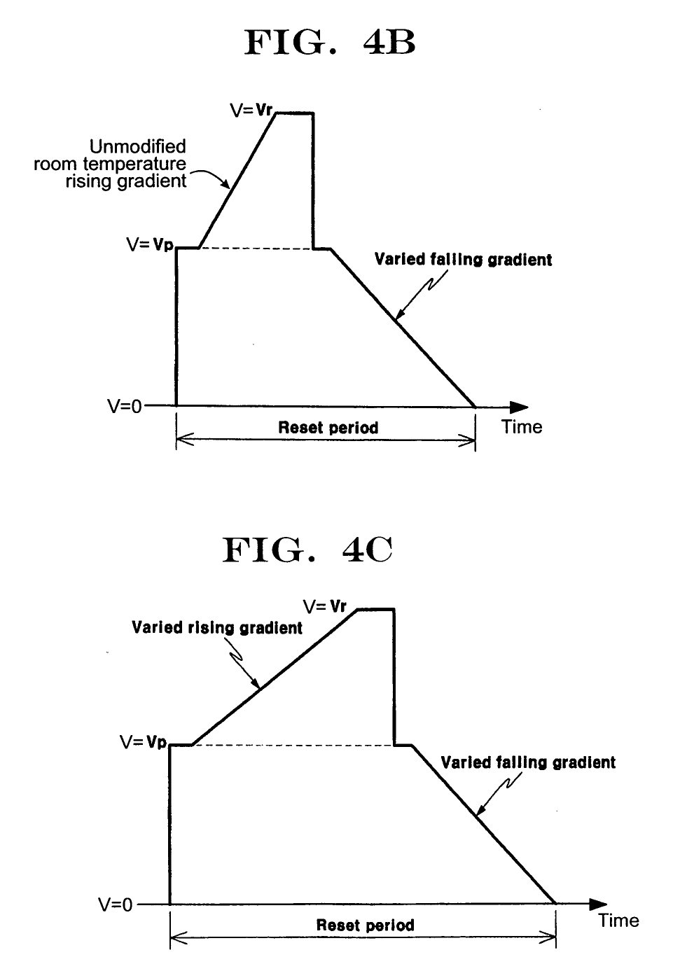

When receiving the modified gradient values from memory 210 in PDP logic circuit 200, the PDP driving circuit 300 generates a driving voltage waveform according to the modified gradient values. Turning to FIGS. 4A through 4C, FIGS. 4A through 4C illustrate various voltage waveforms versus time for a reset period in a plasma display. As illustrated in these figures, the reset period generally has a rising period where the voltage magnitude rises at a fixed rate per unit time and a falling period where the voltage magnitude falls at a fixed rate per unit time. The reset time period may also have a period between the rising and the falling period where the voltage is held at a constant value for some time.

In a typical PDP, when the temperature gets too low, for example, significally below freezing, since the secondary emission coefficient “γ” of the MgO protective film 3 falls off, the same voltage waveform used for room temperature does not produce good image results when used in extreme cold conditions as the PDP will not function properly. Therefore, what is needed is that the voltage waveform must be changed when the temperature gets too cold in order to compensate for the drop in the secondary emission coefficient “γ”. This is done by sensing the external temperature “T”, reading out of memory the proper falling and/or rising voltage gradients for the reset period, and modifying the reset voltage waveform accordingly SO that the PDP will function properly in extreme cold.

Turning now to FIG. 4A, FIG. 4A illustrates an unmodified reset waveform, and FIGS. 4B and 4C illustrate waveforms with the modified gradients in the reset period. Specifically, FIG. 4B illustrates a reset waveform where the falling voltage gradient only is modified, and FIG. 4C illustrates a reset waveform with modified gradients during both the rising period and the falling period.

A field is made up of many subfields. The term “field” and “subfield” are time intervals where signaling and display occurs. Each subfield in the PDP driving method includes a reset period, an address period, a sustain period, and an erase period in a temporal operation variation. Thus, the reset period is one occurrence that occurs during a subfield. In the reset period of each subfield, a ramp voltage, which gradually rises from the voltage of Vₚ which is less than the discharge firing voltage to the voltage of Vᵣ which exceeds the discharge firing voltage, is applied to the scan electrodes Y₁ to Yₙ as illustrated in FIG. 4A. The term “ramp voltage” means that the voltage, as plotted versus time, produces a straight line and not a curved line. Thus, the voltage either rises or falls a fixed amount per unit time for a ramp voltage. In other words, the first time derivative of the ramp voltage is a constant.

Weak discharges are generated from the scan electrodes Y₁ to Yₙ to the address electrodes A₁ to Aₘ and the sustain electrodes X₁ to Xₙ while the ramp voltage rises. Negative wall charges are accumulated near the scan electrodes Y₁ to Yₙ, and positive charges are accumulated near the address electrodes A₁ to Aₘ and the sustain electrodes X₁ to Xₙ by the weak discharges. A ramp voltage which gradually falls from the voltage of Vₚ which is lower than the discharge firing voltage to 0V is applied to the scan electrodes Y₁ to Yₙ. Accordingly, weak discharges are generated from the sustain electrodes X₁ to Xₙ and the address electrodes A₁ to Aₘ to the scan electrodes Y₁ to Yₙ because of the wall charge formed near the discharge cell while the ramp voltage falls.

Part of the wall charges formed on the sustain electrodes X₁ to Xₙ, the scan electrodes Y₁ to Yₙ and the address electrodes A₁ to Aₘ are erased by the discharges, and the wall charges are established to be suitable for the addressing operation. In this instance, when the secondary emission coefficient “γ” is reduced because of a very low external temperature, an appropriate reset process is not performed through the general, unmodified gradient of the rising period and the gradient of the falling period in the reset period. In other words, the voltage waveform used in the reset period for room temperature will not produce a satisfactory display if that same waveform is used in sub-freezing conditions.

Control to generate a stable discharge is performed by correcting for the reduction of the secondary emission coefficient “γ” caused by the decrease of temperature “T” since the amount of the wall charge accumulated in the PDP cells can be minutely controlled by adjusting the voltage gradients as illustrated in FIGS. 4B and 4C. In this instance, the gradient can be modified during the falling period only of the reset period as illustrated in FIG. 4B since the falling period of the reset period is more important than the rising period of the reset period in view of its effect on the accumulation of wall charges. By modifying the rate of change of voltage during the falling period only, all the cells may be adequately addressed, even when the external temperature is very low. In another embodiment, the gradients for both the rising period and the falling period and not just the falling period only can be modified as illustrated in FIG. 4C. In either case, the gradients for the falling voltage and for the rising voltage are reduced at lower temperatures to compensate for the drop in the secondary emission coefficient “γ”. In other words, the slope of the voltage versus time is reduced at lower temperatures in order to produce a quality image and in order to compensate for the reduction in the secondary emission coefficient “γ”.

The method for the PDP driving circuit 300 to modify the gradients of the driving waveform is realized by varying the resistance of R in an RC resonance when generating the ramp waveform of the rising period or the falling period in the reset period. That is, the resistance of R is varied in the RC resonance for generating the ramp waveform according to the value transmitted from the PDP logic circuit 200. Since the detailed method for modifying the gradient of the waveform of the reset period is known by a person skilled in the art, no corresponding description will be provided.

The PDP driving circuit 300 applies a waveform which is generated by modifying the gradients of the ramp waveform of the falling period and/or the rising period of the reset period to the PDP 20 to thereby correct degradation of the secondary emission coefficient “γ” caused by reduction of the temperature “T” and to provide for stable discharges. As described, erroneous operations caused by the reduction of the secondary emission coefficient “γ” according to the reduction of the external temperature “T” are prevented by modifying the gradient of the falling period and/or the rising period of the reset period of the PDP according to the external temperature.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A method of driving a PDP, comprising:
measuring an external temperature of the PDP; and
controlling a gradient of a falling voltage versus time applied to a first electrode during a reset period, said gradient being based on the measured external temperature of the PDP.

2. The method of claim 1, further comprising, during the reset period, controlling a gradient of a rising voltage versus time applied to the first electrode, said gradient of the rising voltage being based on the measured external temperature of the PDP.

3. The method of claim 1, the falling gradient applied to the first electrode becomes smaller when the measured temperature is reduced.

4. The method of claim 2, the rising gradient applied to the first electrode becomes smaller when the measured temperature is reduced.

5. The method of claim l, the falling voltage is a ramp voltage.

6. The method of claim 2, the rising voltage is a ramp voltage.

7. A plasma display device, comprising:
a PDP comprising a plurality of address electrodes, and a plurality of scan electrodes and sustain electrodes arranged in pairs with the address electrodes;
an external temperature sensor arranged to measure an external temperature of the PDP;
a logic unit arranged to store gradient data of a falling voltage during a reset period according to the external temperature measured by the external temperature sensor; and
a driving circuit arranged to drive the PDP according to the gradient data transmitted from the logic unit.

8. The plasma display device of claim 7, the logic unit further being arranged to store gradient data of a rising voltage during the reset period according to the external temperature measured by the external temperature sensor.

9. The plasma display device of claim 7, the logic unit comprises a memory arranged to store the gradient data during the reset period according to the external temperature.

10. The plasma display device of claim 7, the logic unit being arranged to store gradient data of another voltage that allows the gradient of the voltage to be smaller as the external temperature is reduced.

11. The plasma display device of claim 7, the falling voltage is a ramp voltage.

12. The plasma display device of claim 8, the rising voltage is a ramp voltage.

13. A method of driving a PDP, comprising:
sensing an external temperature of the PDP;
accessing a look up table to look up a falling voltage versus time gradient value based on the sensed temperature to be used in the reset period; and
driving electrodes in the PDP according to the gradient value found in the look up table.

14. The method of claim 13, further comprising accessing the look up table to look up a rising voltage versus time gradient value based on the sensed temperature to be used in the reset period, and wherein the driving is according to both the rising and the falling gradient values found in the look up table.

15. The method of claim 14, all of the falling gradient values in the look up table being equal to each other for temperatures above a predetermined temperature.

16. The method of claim 15, the predetermined temperature being 0 degrees Celsius.

17. The method of claim 14, all of the rising gradient values in the look up table being equal to each other for temperatures above a predetermined temperature.

18. The method of claim 13, both of the rising and the falling gradient values stored in the look up table decrease in magnitude for decreasing temperatures that are below a predetermined temperature.

19. The method of claim 18, the predetermined temperature being −10 degrees Celsius.

20. The method of claim 13, the look up table being a table linking time voltage gradients to temperatures.
